(19) United States
(12) Patent Application Publication
(10) Pub. No.: US 2018/0232823 A1
(43) Pub. Date: Aug. 16, 2018

(54) Real Estate Social Media

(71) Applicant: Matthew Steel, Bellevue, WA (US)

(72) Inventor: Matthew Steel, Bellevue, WA (US)

(21) Appl. No.: 15/433,764

(22) Filed: Feb. 15, 2017

(51) Int. Cl. G06Q 50/16; G06Q 50/00; H04L 12/58

(52) U.S. Cl. CPC G06Q 50/16; H04L 51/32; G06Q 50/01

(57) ABSTRACT

A lockbox may transmit a signal when an authorized person visits a real property. In response to the signal, a request for a review of the property may be sent to the person. If a review is received, it may be posted on a social media page dedicated to the real property.

### FIELD

The instant application relates generally to real estate information and collection and dissemination on social media.

### BACKGROUND

In today's data-rich environment, buyers are looking for a variety of information to assist them in determining the value of what they intend to purchase. This is especially true of large purchases, such as real property, where a real property buyer will typically spend a lot of time reviewing all available information related to the real property.

Purchasing real property is a unique experience because no two real properties are exactly alike. Each real property offers a different value to each potential real property buyer.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, Real Estate Social Media, which may collect information on a real property and post information on social media. This may include techniques that can be used to capture information from real estate agents who enter real property that is for sale. A real estate agent may, for example, use a code to open a lockbox, containing a key to gain entry to the real property. Upon entering the code associated with the real estate agent, the lockbox may wirelessly send information to a service, which may notify Real Estate Social Media. Real Estate Social Media may then ask the real estate agent to submit a review on the real property, which may be posted on social media.

### BRIEF DESCRIPTION OF THE DRAWINGS

FIG. 1 is an example of a system on which Real Estate Social Media may be implemented according to one embodiment.

FIG. 2 illustrates an example of a lockbox attached to real property.

FIG. 3 illustrates an example of a computer system and network that support a lockbox.

FIG. 4 illustrates a component diagram of a computing device according to one embodiment.

Like reference numerals are used to designate like parts in the accompanying drawings.

### DETAILED DESCRIPTION

Real Estate Social Media may provide techniques to collect information on a real property and post information on a social media site. This may include capturing information from real estate agents who enter real property that is for sale. A real estate agent may, for example, use a code to open a lockbox, containing a key to gain entry to the real property. Upon entering the code associated with the real estate agent, the lockbox may wirelessly send information to a service, which may notify Real Estate Social Media. This information may include the real estate agent's name, contact information, and website or it may be an ID that is associated with the real estate agent. Real Estate Social Media may then ask the real estate agent to submit a review on the real property, which may be posted on the social media site.

Alternatively, a real estate agent may have a GPS indicating proximity to a real property, which may send information to Real Estate Social Media. Real Estate Social Media may then ask the real estate agent to submit a review on the real property, which may be posted on the social media site.

In another embodiment, a real estate agent may have an app designed to work with Real Estate Social Media, and may notify Real Estate Social Media when the real estate agent visits a real property. Real Estate Social Media may then ask the real estate agent to submit a review on the real property, which may be posted on the social media site.

One having skill in the art will recognize that many different ways may be used to notify Real Estate Social Media that a real estate agent is at a real property.

Based on the information received from the lockbox or through other means, a real property seller may know how many real estate agents have entered the real property, how long each real estate agent stayed on the real property, which real estate agents are returning to the property on multiple occasions and contact information for each real estate agent. From this information, the real property seller may be able to gather the interest in their property which can be of assistance if additional marketing is needed in order to sell the real property.

The lockbox may also alert the real property seller if an unauthorized person has attempted to open the lockbox or remove the lockbox from the real property.

When selling real property, efforts are made to make the real property buyer feel like they belong in the property. This feeling is reduced if the real property sellers are present when the real property buyers are looking at the property. Therefore, it is generally common for the real property sellers to leave the property prior to the time when the real property buyers plan to be at the real property and return only after the real property buyers have left. The lockbox may send an alert when the real estate agent has left the real property signaling the real property owner can return to the real property.

The information may be captured on the social media site and combined with additional information, for example, the location, size, characteristics, and impressions of other real estate agents and real estate buyers to the real property. The real property seller can contact the real estate agents to get their impressions of the real property and capture that information on a single location so prospective real property buyers can review all the information about a real property.

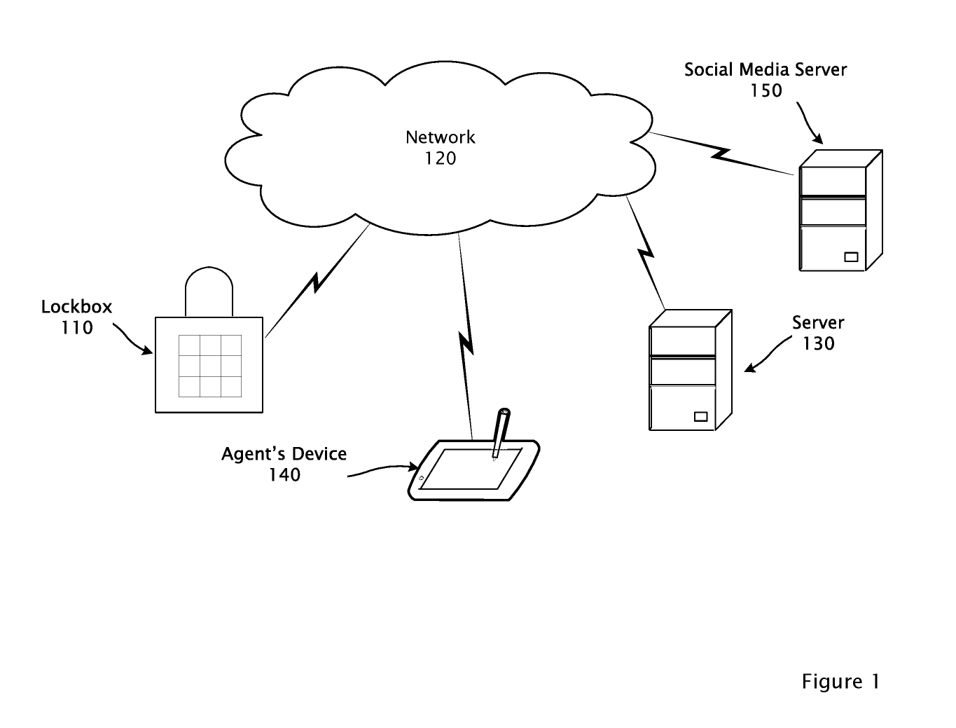

FIG. 1 is an example of a system on which Real Estate Social Media may be implemented. Lockbox 110 may allow a real estate agent to enter a code assigned to the agent to obtain access to a real property by, for example, providing a key or directly opening a door. Lockbox 110 may transmit information concerning the access via Network 120. This information may include identification of the property and the agent. This information may be sent directly to Server 130, or may be sent to a hosting service, such as a multiple listing service, which may then send a notification to Server 130.

Network 120 may include Wi-Fi, cellular data access methods, such as 3G or 4GLTE, the Internet, local area networks, wide area networks, or any combination of these or other means of providing data transfer capabilities.

Server 130 may receive a notification including the identification of the property and the agent, and may send a request to the agent, asking the agent to write a review of the property.

Server 130 may include one or more computers, and may serve a number of roles, including, but not limited to, storing and retrieving: content, configuration information, user preferences, and security credentials.

The agent may receive the request on Agent's Device 140, which may be a desktop computer, a laptop computer, a tablet, a smartphone, a cell phone, a wearable device such as a smartwatch, activity tracker or intelligent eyewear, a specialized device for this application, or any other type of device capable of receiving notifications.

If the agent writes a review of the property, that review may be received by Server 130, which may check to see if there is a profile for the property on a social media site. If there is, Server 130 may post the review to Social Media Server 150, which may allow the review to be displayed on the profile for the property on the social media site. If there is not a profile, Server 130 may issue a request to Social Media Server 150 to create one, and then post the review. Server 130 or Social Media Server 150 may determine if there is authorization to share information about the property.

One skilled in the art will recognize that Agent's Device 140, Social Media Server 150, and Server 130 may be of many different designs and may have different capabilities.

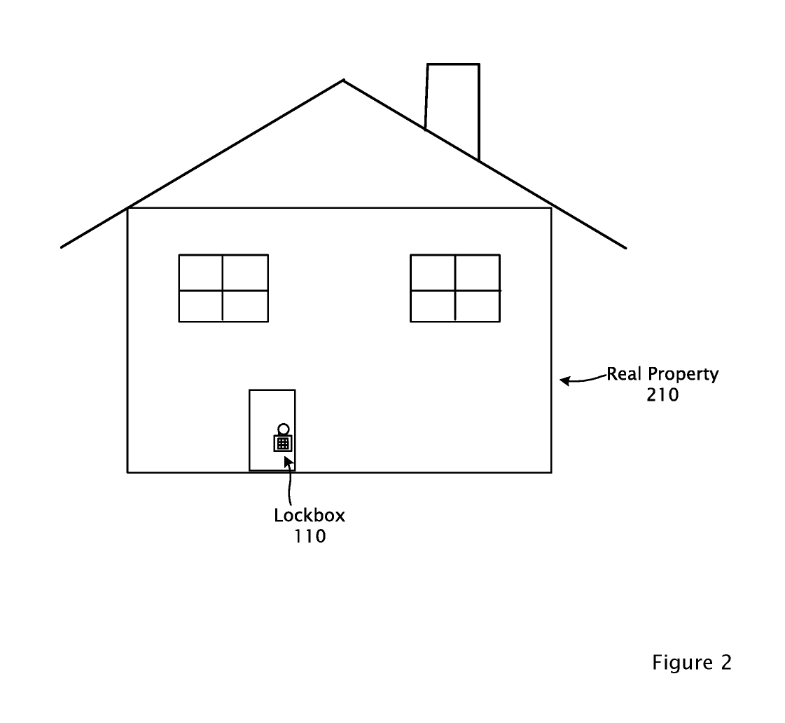

FIG. 2 illustrates an example of Lockbox 110 attached to Real Property 210. Lockbox 110 may be located on a door handle or in a location near a lock to open Real Property 210. Real Property 210 may be a house, condo, a business, a farm, or any other type of real property.

When an agent opens Lockbox 110, Lockbox 110 may use, for example, Wi-Fi or cellular data to transmit information concerning the property and the agent to Server 130.

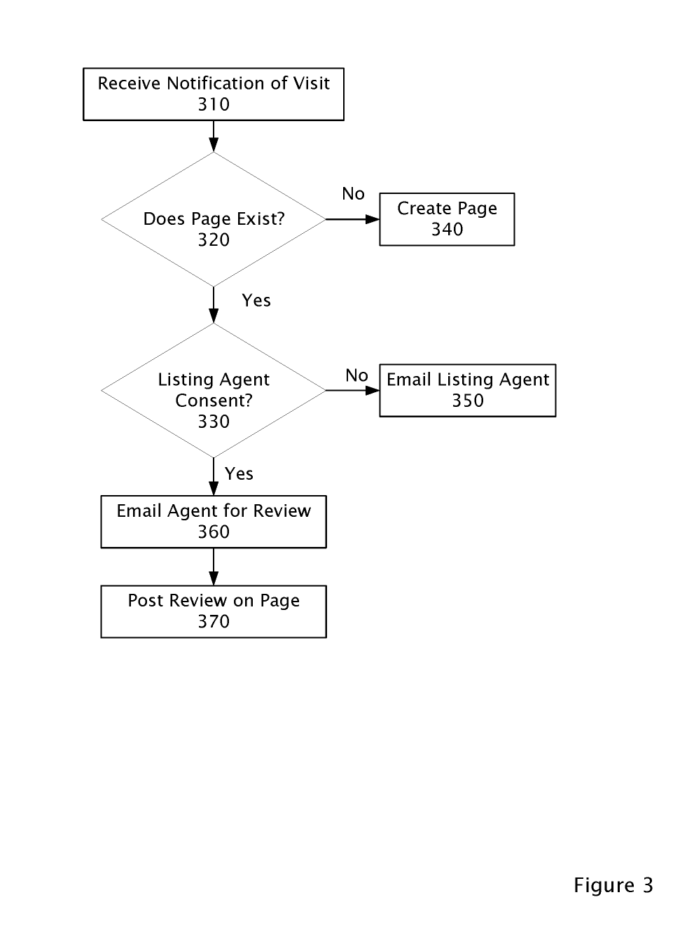

FIG. 3 is a flowchart of Real Estate Social Media, according to one embodiment. A Notification of a Visit may be Received 310, indicating that an agent has visited Real Property 210. At Does Page Exist 320, a query may be made to test if a page exists on social media for Real Property 210. If a page does not exist (No), a Page may be Created 340. If a page does exist (Yes), a test may check if Listing Agent Consent 330 has been granted to ask the agent for a review of the property. If the Listing Agent has not consented (No), the Listing Agent may be Emailed 350 asking permission to obtain and post reviews of Real Property 210. If Yes, Email may be sent to Agent asking for a Review 360. The Review may then be Posted on Page 370, on a social media site.

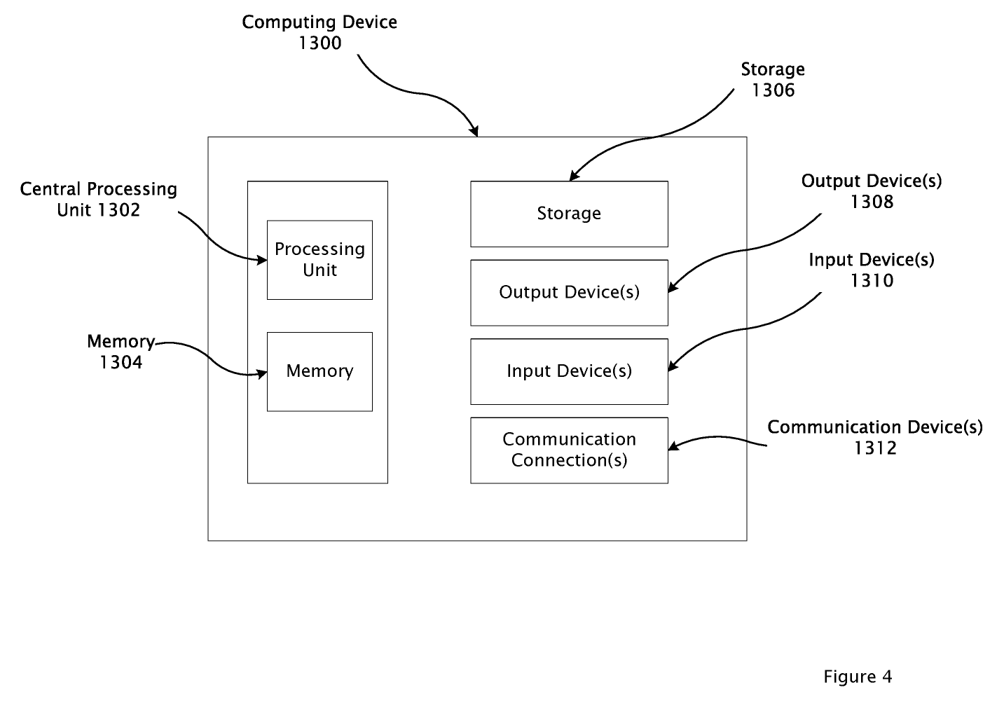

FIG. 4 illustrates a component diagram of a computing device according to one embodiment. Computing Device 1300 can be utilized to implement one or more computing devices, computer processes, or software modules described herein, including, for example, but not limited to, Lockbox 110, Agent's Device 140, Server 130, or Social Media Server 150. In one example, Computing Device 1300 can be utilized to process calculations, execute instructions, receive and transmit digital signals. In another example, Computing Device 1300 can be utilized, for example, to process calculations, execute instructions, receive and transmit digital signals, receive and transmit search queries, and hypertext, or compile computer code. Computing Device 1300 can be any general or special purpose computer now known or to become known capable of performing the steps and/or performing the functions described herein, either in software, hardware, firmware, or a combination thereof.

In its most basic configuration, Computing Device 1300 typically includes at least one Central Processing Unit (CPU) 1302, also known as a processor, and Memory 1304. Depending on the exact configuration and type of Computing Device 1300, Memory 1304 may be volatile (such as RAM), non-volatile (such as ROM, flash memory, etc.) or some combination of the two. Additionally, Computing Device 1300 may also have additional features/functionality. For example, Computing Device 1300 may include multiple CPU's. The described methods may be executed in any manner by any processing unit in Computing Device 1300. For example, the described process may be executed by both multiple CPUs in parallel.

Computing Device 1300 may also include additional storage (removable and/or non-removable) including, but not limited to, magnetic or optical disks or tape. Such additional storage is illustrated in FIG. 4 by Storage 1306. Computer storage media include volatile and nonvolatile, removable and non-removable media implemented in any method or technology for storage of information such as computer-readable instructions, data structures, program modules or other data. Memory 1304 and Storage 1306 are all examples of computer storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which may be accessed by Computing Device 1300. Any such computer-readable storage media may be part of Computing Device 1300. But computer-readable storage media does not include transient signals.

Computing Device 1300 may also contain Communications Device(s) 1312 that allow the device to communicate with other devices. Communications Device(s) 1312 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device 1300 may also have Input Device(s) 1310 such as a keyboard, mouse, pen, voice input device, touch input device, etc. Output Device(s) 1308 such as a display, speakers, printer, etc. may also be included. All these devices are well known in the art and need not be discussed at length.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

With respect to the use of any plural and/or singular terms herein, those having skill in the art may translate from the plural to the singular and/or from the singular to the plural as is appropriate to the context and/or application. The various singular/plural permutations may be expressly set forth herein for the sake of clarity.

While certain example techniques have been described and shown herein using various methods, devices, and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

1. A method, comprising:
receiving, from a lockbox, a notification that a person has visited a real property;
checking to see if a page on social media exists for that real property, and creating one if one does not exist;
testing if permission was granted to post a review, and requesting permission if it had not been previously obtained;
requesting a review from the person if permission was granted;
receiving the review; and
posting the review on the page on social media.
